(19) United States
(12) Patent Application Publication
(10) Pub. No.: US 2012/0271460 A1
(43) Pub. Date: Oct. 25, 2012

(54) UNIVERSAL DEMAND-RESPONSE REMOTE CONTROL FOR DUCTLESS SPLIT SYSTEM

(76) Inventor: Roger W. Rognli, Otsego, MN (US)

(21) Appl. No.: 13/092,733

(22) Filed: Apr. 22, 2011

(51) Int. Cl. G05D 23/19

(52) U.S. Cl. 700/276; 236/51

(57) ABSTRACT

A universal demand-response remote-control device for controlling a control unit of a ductless, split air-conditioning system. The remote-control device includes a long-distance communications module and includes a local communications module. The remote-control device also includes a processor in electrical communication with the long-distance communications module and the local communications module.

### FIELD OF THE INVENTION

The present invention relates generally to management and control of electrical loads. More particularly, the present invention relates to management and control of electrical loads of ductless heating and air-conditioning systems using a universal, demand-response remote-control device.

### BACKGROUND OF THE INVENTION

Utilities need to match generation to load, or supply to demand. Traditionally, this is done on the supply side using Automation Generation Control (AGC). As loads are added to an electricity grid and demand rises, utilities increase output of existing generators to solve increases in demand. To solve the issue of continuing long-term demand, utilities invest in additional generators and plants to match rising demand. As load levels fall, generator output to a certain extent may be reduced or taken off line to match falling demand. Although such techniques are still used, and to a certain extent still address the problem of matching supply with demand, as the overall demand for electricity grows, the cost to add power plants and generation equipment that serve only to fill peak demand makes these techniques extremely costly. Further, the time required to increase generator output or to take generators online and take generators offline creates a time lag, and a subsequent mismatch between supply and demand.

In response to the limitations of AGC, electric utility companies have developed solutions and incentives aimed at reducing both commercial and residential demand for electricity. In the case of office buildings, factories and other commercial buildings having relatively large-scale individual loads, utilities incentivize owners with differential electricity rates to install locally-controlled load-management systems that reduce on-site demand. Reduction of any individual large scale loads by such a load-management systems may significantly impact overall demand on its connected grid.

In the case of individual residences having relatively small-scale electrical loads, utilities incentivize some consumers to allow them to install demand response technology at the residence to control high-usage appliances such as air-conditioning (AC) compressors, water heaters, pool heaters, and so on. Such technology aids the utilities in easing demand during sustained periods of peak usage.

Traditional demand-response technology used to manage thermostatically-controlled loads such as AC compressors typically consists of a demand-response thermostat or a load-control relay (LCR) device. Such demand-response devices traditionally receive commands over a long-distance communications network for controlling the electrical load. A demand-response thermostat generally controls operation of a load by manipulating space temperature or other settings to control operation. An LCR device is wired into the power supply line of the AC compressor or other electrical load, and interrupts power to the load when the load is to be controlled.

Such demand-response thermostats, LCR devices, and other known demand-response devices are designed to be used with a wide variety of ducted, thermostatically-controlled HVAC systems as commonly used in single-family residences in the United States. Typical ducted HVAC systems in the United States utilize distinct and separate thermostat devices, circulation fan controls, electrical contactors, switches, and so on, that are easily accessible for connection to demand-response devices. Further, most control logic relies on analog control voltages for operation. For example, 24 VAC is commonly used for thermostatic control. As such, demand-response devices are designed to operate with such systems, and may be installed into most ducted, thermostatically-controlled HVAC systems.

For a variety of reasons, however, these kinds of demand-response technology are not readily adapted to ductless, split heating and cooling systems. Ductless heating and cooling systems, such as mini-split AC systems, are often installed in residences including multi-unit apartment buildings that do not have basements or attics to accommodate air-handling ducts, and are typically used to cool relatively small spaces, such as a single room. Such compact mini-split systems can include an outdoor condensing unit with an AC compressor coupled to an indoor, often wall-mounted, evaporating unit with a fan. Operation of the mini-split unit is generally controlled locally by a user operating a handheld infrared remote controller. The unit may or may not include a temperature sensor or thermostatic device.

Because of the compact nature of ductless, mini-split units, as well as the variety of digital control schemes employed by different manufacturers, traditional demand-response devices cannot be used with these kinds of ductless heating and cooling systems. Consequently, in regions where ductless heating and cooling systems are commonly used, electrical utilities cannot provide demand-response devices to their customers, and cannot implement programs to match energy demand and supply.

### SUMMARY OF THE INVENTION

In an embodiment, the present invention comprises a universal demand-response (DR) remote-control device for controlling an infrared-responsive control unit of a ductless, split air-conditioning system. The universal DR remote-control device includes a long-distance communications module including a long-distance transceiver, the long-distance communications module providing a network connection to a long-distance communications network transmitting a load-control message for controlling an electrical load of a ductless, split air-conditioning system at a premise. The universal DR remote-control device also includes a processor in electrical communication with the long-distance communications module, and a first local communications module in electrical communication with the processor and the long-distance communications module. The first local-communications module includes a local transceiver transmitting a command associated with the received load-control message to an infrared-responsive control unit of the ductless, split air-conditioning system located inside a premise, thereby controlling operation of the electrical load. The infrared-responsive control unit is located inside the premise, and the electrical load is located outside the premise.

In another embodiment, the present invention comprises a remote-control system for controlling a plurality of ductless, split air-conditioning units. The remote-control system comprises a master station that includes a long-distance communications module including a long-distance transceiver. The long-distance communications module provides a network connection to a long-distance communications network transmitting load-control messages for controlling electrical loads of one or more ductless, split air-conditioning systems. The master station also includes a local-communications module including a local transceiver, and a processor in electrical communication with the long-distance communications module and the master local-communications module. The system also includes first and second handheld remote-control devices in communication with the master station. Each of the handheld remote-control devices includes a local communications module including a local transceiver receiving load-control message data from the master station and transmitting commands associated with the load-control message data to an indoor control unit of the one or more ductless, split air-conditioning systems, thereby controlling operation of the electrical loads of the one or more ductless, split air-conditioning systems.

In yet another embodiment, the present invention comprises a method of controlling an electrical load of a ductless, split air-conditioning system outside a premise and controlled by a remote-control device located inside the premise. The method includes causing a remote-control device having a long-distance communications module and a local communications module to be provided to a user, the long-distance communications module configured to interface with a long-distance communications network and the local communications module configured to communicate with an inside control unit of a ductless, split air-conditioning system having an outside unit with an electrical load. The method also includes transmitting a load-control message over the long-distance communications network to the long-distance communications module of the remote-control device located inside the premise, the load-control message causing the remote-control unit to transmit a load-control command to the inside control unit of the indoor portion of the ductless, split air-conditioning unit, thereby controlling power to the electrical load.

In another embodiment, the present invention includes a method of operating a remote-control device in communication with a long-distance communications network at a premise that includes the remote-control device inside the premise and an electrical load of a ductless, split air-conditioning system outside the premise and controlled by the remote-control device. The method includes receiving a load-control message over a long-distance communications network at a remote-control device located inside a premise, the remote-control device including a long-distance communications module and a local communications module. The method also includes in response to the received load-control message, transmitting a load-control command associated with the load-control message from the remote-control unit to a control unit of an inside portion of a ductless, split air-conditioning unit, thereby controlling power to the electrical load of the ductless, split air-conditioning system.

### BRIEF DESCRIPTION OF THE DRAWINGS

The invention may be more completely understood in consideration of the following detailed description of various embodiments of the invention in connection with the accompanying drawings, in which:

FIG. 1 is a diagram of a system having a master controller communicating over a long-distance communications network to multiple demand response remote controllers at local premises, according to an embodiment of the present invention;

FIG. 2 is a block diagram of a universal demand-response remote control device, according to an embodiment of the present invention.

FIG. 3 is a block diagram of a ductless, split demand-response system including the universal demand-response remote control device of FIG. 2, according to an embodiment of the present invention; and

FIG. 4 is a flowchart depicting the configuration and operation of the universal demand-response remote-control device according to an embodiment of the present invention.

While the invention amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

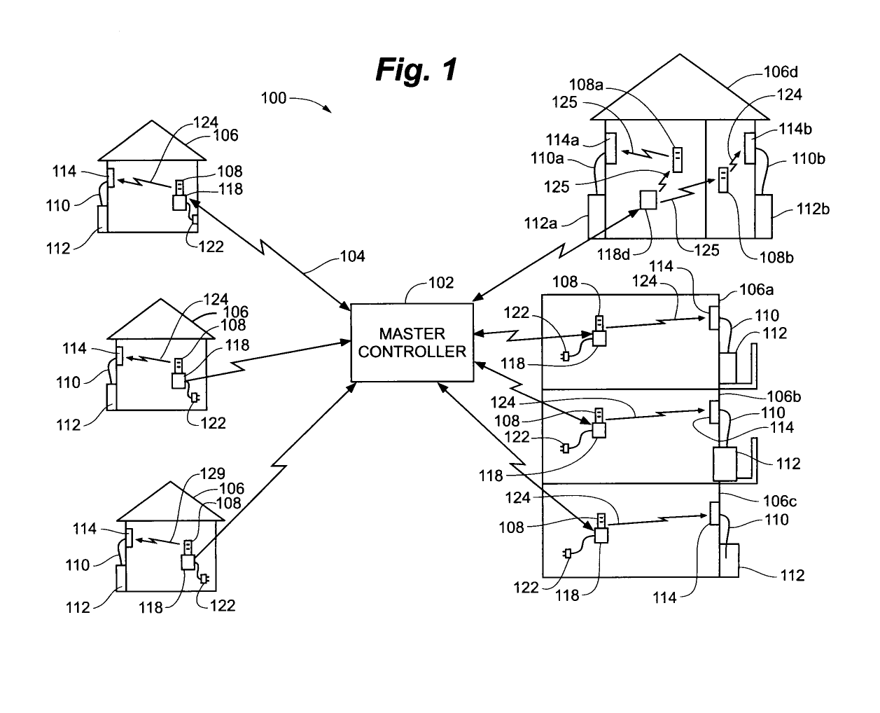

Referring to FIG. 1, in an embodiment, demand-response system 100 for controlling multiple, distributed ductless heating or cooling systems is depicted. System 100 includes master controller 102 communicating over communications network 104 to multiple premises 106. Master controller 102 may be located at a centrally-located electrical utility control location substation or other location. Premises 106 may include single-family residences, buildings with multiple units, such as 106a, 106b, and 106c, or any other type of building or structure housing ductless heating or cooling systems.

Each premise 106 includes a universal demand-response (DR) remote-control unit 108 controlling a ductless, split heating or cooling system 110. Universal DR remote-control 108 replaces the original, manufacturer-provided remote-controller, providing similar control features, as well as demand-response functionality, and in some cases, enhanced thermostat functionality.

Some premises 106 may include multiple ductless, split heating or cooling systems 110, such as 110a and 110b depicted, in a single premise, such as premise 106d, with one or more universal DR remote control devices 108, such as devices 108a and 108b. Further, in some embodiments, system 100 may include premises including known demand-response devices for controlling traditional HVAC systems, rather than ductless heating or cooling systems. In such embodiments, master controller 102 may communicate with both known demand-response devices and universal DR remote-control devices 108 of the present invention.

Each ductless, split heating or cooling system 110 (hereinafter referred to as “split system” 110) includes outside condensing unit 112 electrically and mechanically connected to inside evaporating unit 114, as will be understood by those skilled-in-the-art. In one embodiment, split system 110 comprises a ductless, mini-split air-conditioning system. In other embodiments, split system 110 may comprise a split air-conditioning system, a heat pump, or other similar ductless, split heating and/or cooling system. Split system 110 may also include a manufacturer-provided wireless remote controller (not depicted).

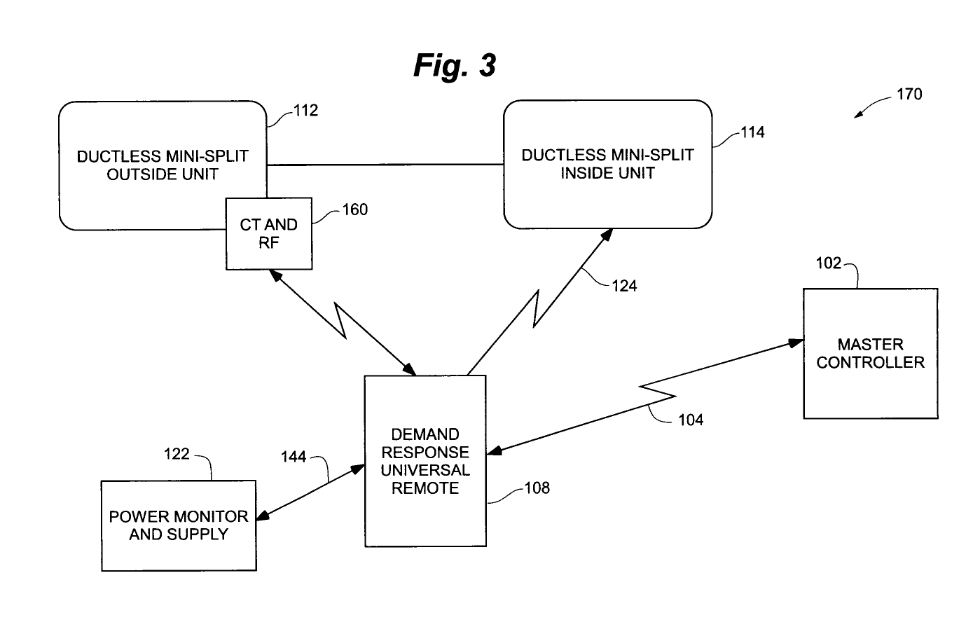

As described further below with respect to FIG. 3, universal DR remote control unit 108 may include an optional master station 118. When present, master station 118 provides battery charging power for universal DR remote-control device 108, and may also serve to position DR remote-control device 108 for optimal communications with split system 110. Master station 118 may also be coupled to power unit 122 for plugging into a wall outlet to receive electrical power. In other embodiments, master station 118 may include some of the communications and processing capabilities of universal DR remote-control device 108 so as to serve as a master controller to multiple devices 108 at a single premise 106.

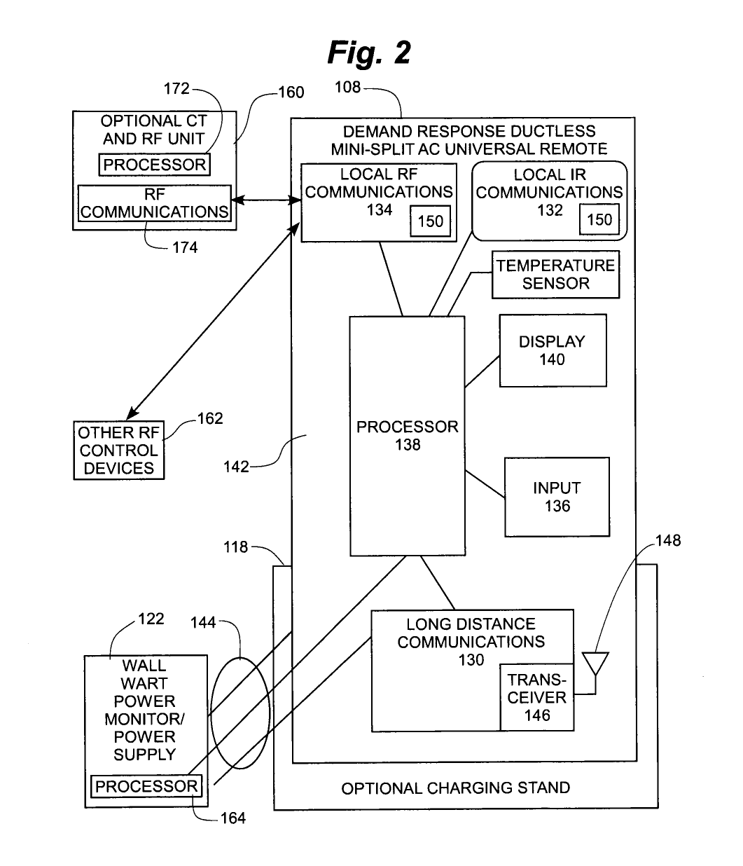

In general operation, and as described further below with respect to FIGS. 2 and 3, master controller 102 communicates with universal DR remote control device 108 over communications network 104.

Communications network 104 in one embodiment is a long-distance communications network facilitating one-way or two-way transmission of data between master controller 102 and universal DR remote-control device 108. Data, often in the form of load-control messages or commands, is transmitted using a variety of known wired or wireless communication interfaces and protocols including power line communication (PLC), broadband or other Internet communication, radio frequency (RF) communication, and others.

In an embodiment wherein communications network 104 comprises an RF communications network, network 104 can be implemented with various communication interfaces including, for example, VHF POCSAG paging, FLEX one-way or two-way paging, AERIS/TELEMETRIC Analog Cellular Control Channel two-way communication, SMS Digital two-way communication, or DNP Serial compliant communications for integration with SCADA/EMS communications currently in use by electric generation utilities.

Master controller 102 transmits load-control messages to universal DR remote-control device 108. Universal DR remote-control unit 108 acts upon the received load-control messages by transmitting local commands wirelessly to manipulate operation of split system 110. For example, load control messages may include commands to turn split system 110 on or off, or to raise or lower a space temperature.

Load-control messages over communications network 104 may be formatted according to a variety of networking technologies and protocols. In one embodiment, load-control messages may be formatted according to a proprietary protocol, such as an Expresscom® protocol as is described in U.S. Pat. No. 7,702,424 and U.S. Pat. No. 7,869,904, both entitled “Utility Load Control Management Communications Protocol”, assigned to the assignees of the present application, and herein incorporated in their entireties by reference.

Implementation of one such protocol includes the steps of: selecting at least one target for load control and assigning the at least one target at least one target address; using a control system of a utility provider to form a single variable length load control message according to a communication protocol. The load control message includes the at least one target address and a plurality of unique concatenated command messages as part of the single variable length load control message. Each of the plurality of unique concatenated command messages is selected from the set consisting of a command message having a predetermined message type and a fixed length message defined for the predetermined message type and a command message having a predetermined message type and a variable length message corresponding to values in a command message control flag field defined for the predetermined message type. The single variable length load control message is transmitted via a long-distance communication network to the at least one target for execution of the variable length load control message. The at least one target comprises an individual end user device and the at least one target address comprises a device-level address. In a network capable of two-way communication, the steps also include receiving a reply message formed according to the communication protocol via a communication network at the master utility station from the at least one target after the load control message is transmitted.

Referring to FIG. 2, an embodiment of universal DR remote-control device 108 is depicted. In this embodiment, universal DR remote-control device 108 includes long-distance communications module 130, first local-communications module 132, optional second local-communications module 134, user input 136, processor 138, display 140, and optional temperature sensor 141. It will be understood that universal DR remote-control device 108 may also include other appropriate electronic components and circuitry such as memory devices, power supply and conditioning circuits, and so on.

The various components of universal DR remote-control unit 108 are enclosed by housing 142, which in an embodiment comprises a size and shape appropriate for being held in the hand of a user. In other embodiments, DR remote-control unit 108 may be a stationary device that includes a housing 142 adapted to be set on a tabletop, or mounted to a wall. Universal DR remote-control unit 108 may also include master station 118, power unit 122, and one or more cables 144.

Long-distance communications module 130 includes various hardware and software components enabling universal DR remote-control device 108 to connect to, and communicate over, long-distance communications network 104, including communicating with master controller 102. As such, long-distance communications module 130 provides a network interface to any of the long-distance communication network 104 types described above, including PLC, Internet, RF, including cellular and paging, and so on. Communications may be one-way or two-way over long-distance communications network 104.

In an embodiment, components of long-distance communications module include transceiver 146, antenna 148, and other components such as memory devices storing computer software programs, and other electronic circuitry. Transceiver 146 may facilitate two-way communications, or in the case of transceiver 146 being limited to a receiver, facilitate only one-way communications. Long-distance communications module 130 also includes a protocol software stack for decoding and encoding. Such a software stack may comprise a commercially-available stack, or a proprietary stack, such as one used for the proprietary Expresscom protocol discussed above.

First local-communications module 132 enables universal DR remote-control device 108 to communicate locally, and wirelessly, with a control unit of split system 110. In an embodiment, first local-communications module 132 includes various hardware components and software programs for locally transmitting wireless signals, and in some embodiments, for receiving wireless signals. Module 132 may include transceiver 150 and other components such as memory devices storing computer software and other electronic circuitry.

In one embodiment, first local-communications module 132 comprises an infrared (IR) module, transmitting and/or receiving IR signals. In such an embodiment, transceiver 150 of first local-communications module 132 may include an infrared light-emitting diode (LED) and an infrared-sensitive phototransistor for transmitting and receiving signals, respectively.

In other embodiments, module 132 comprises an RF module that operates according to any of a variety of short-range wireless protocols, including ZigBee®, ZWave®, WiFi®, or other radio protocols. In such an embodiment, transceiver 150 may comprise a radio transceiver or receiver and a radio antenna.

Local-communications module 132 may also include a protocol software stack. Such a stack may comprise a proprietary stack, but in an embodiment, may comprise one of various commercially-available, and known, software stacks. Such known, third-party stacks may include an infrared, IrDA stack as provided by, for example, Embedmet, a commercially-available WiFi 802.11 stack, a commercially-available ZigBee stack, and so on.

Universal DR remote-control device 108 may also include second local-communications module 134. Similar to first local-communications module 132, second local-communications module 134 facilitates short-range, local communications at a premise 106. In an embodiment, second local communications module 134 also includes various hardware components and software programs for locally transmitting wireless signals, and in some embodiments, for receiving wireless signals. Module 134 may include a transceiver 150 and other components such as memory devices storing computer software and other electronic circuitry.

In the embodiment depicted in FIG. 2, first local-communications module 132 comprises an IR module for transmitting one-way commands to a control unit of split system 110, while second local-communications module 134 comprises an RF module that facilitates one-way or two-way communications with power sensor 160, such as a current transformer, or other RF control device 162. In an alternate embodiment, the IR module transmits and receives IR communication signals. In other embodiments, both first and second local communications modules 132 and 134 comprise RF modules. It will be understood that any combination of short-range, wireless communication technologies, including those discussed above, may be implemented in modules 132 and 134.

Further, although depicted as two physically distinct and separate modules, local communication modules 132 and 134 may be integrated into a single package.

Input 136 may comprise a key pad, touch screen, or other structure allowing a user to interface with universal DR remote-control device 108, including to control split system 110. Because universal DR remote-control device 108 is intended to replace, or at least supplement, a standard remote controller provided by a manufacturer for control of split system 110, input 136 may include a key pad or user input structure for turning split system 110 on and off, raising and lowering temperature, setting temperature, controlling fan operations, setting a time display, programming operation, and other such known control features.

Additionally, input 136 may include controls, including push-buttons, for accessing demand-response features and controls unique to DR remote-control device 108. One such feature with an associated push button may be a critical or peak price command button that allows a user to operate split system 110 in response to pricing information. Another feature wherein DR remote-control device 108 receives price signals, allows a user to react to displayed pricing information by opting in or out of a load-control event. Such an opt-out feature may include a simple pushbutton, or other interface to accept user input. Such features, as well as more detail relating to the operation of universal DR remote-control device 108, are discussed further below with respect to FIG. 3.

Processor 138 is electrically and communicatively coupled to long-distance communications module 130, first local communications module 132, second communications module 134, and input 136. In certain embodiments, processor 138 may be a central processing unit, microprocessor, microcontroller, microcomputer, or other such known computer processor. Processor 138 may also include, or be coupled to a memory device comprising any of a variety of volatile memory, including RAM, DRAM, SRAM, and so on, as well as non-volatile memory, including ROM, PROM, EPROM, EEPROM, Flash, and so on. Such memory devices may store programs, software, and instructions relating to the operation of universal DR remote-control device 108.

Optional display 140, coupled to processor 138, displays information to a user, such as set-point temperature, space temperature, time, energy cost, demand-response mode, load control status, and other such information. In some embodiments, display 166 may be an interactive display, such as a touch-screen display.

In some embodiments, universal DR remote-control device 108 may also include temperature sensor 141. Temperature sensor 141 may be used to implement temperature-based load-control or demand-response programs. Further, when DR remote-control device 108 includes temperature sensor 141, device 108 may also include programmable thermostatic functionality, similar to a standard programmable thermostat. Such additional functionality includes the ability to program device 108 to raise or lower a setpoint temperature for different times of day, different days of the week, and other such functionality as associated with known programmable thermostats.

In another embodiment, universal DR remote-control device 108 may also include an occupancy sensor (not depicted). As understood by those skilled in the art, an occupancy sensor generally senses the presence of an individual in a space, such as a room, based on detected motion via IR or acoustical signals. In the case of the universal DR remote-control device 108, the addition of an occupancy sensor enhances the energy-saving capability of the system.

In an embodiment, universal DR remote-control device 108 includes an occupancy sensor and automatically initiates some kind of control over split system 110. Such control might include turning on split system 110 to begin cooling a room immediately upon someone entering, or turning off split system 110 after a predetermined time period following the room or space becoming unoccupied.

Such control might also, or alternatively, include enabling a setpoint temperature to drift by a predetermined number of degrees. In one such embodiment that includes programmable thermostat capability in DR remote-control device 108 or in split system 110, in addition to setting temperature set points and parameters relating to wake, leave, return, and sleep times, a user sets an additional parameter for unoccupied spaces. In an embodiment, an unoccupied space temperature could be set to adjust by an offset number of degrees (drift), for example, two degrees, such that if a space is unoccupied, the customer-provided set points are modified by the predetermined drift or offset. In an embodiment, a user sets a morning wake temperature to 74 degrees Fahrenheit, but if the user does not get up and move around by the preset wake time, as sensed by the occupancy sensor, the wake temperature is allowed to drift upwards by an offset, such as up to 76 degrees.

In an embodiment, if the utility generation mix is such that renewable generation would need to be curtailed by the utility, the utility could instead adjust the drift in order to turn a load on in order to match the load to the available capacity.

In a premise 106 having multiple split systems 110, such as a hotel or multi-room residence, occupancy sensors could be used in each room or space to monitor the absence or presence of persons, and stored commands sent from DR remote-control devices 108 to split systems 110 for controlling systems 110 based on occupancy.

Occupancy sensors and status may also be used to send out stored commands to other devices on the local communications system. For example, if an occupancy sensor detects that a space is unoccupied, DR remote-control device 108 may send a wireless signal via local-communications module 134 to turn off select wall-plug devices in order to control phantom loads, or other non-critical loads, and when sensing that the space is again occupied, may turn these devices back on, or stagger them back one, in a specified order.

In another embodiment, another function may include disrupting a demand-response, or load-control event when a person enters a room. Further, occupancy data may be gathered and analyzed to refine, revise, or reschedule future load-control events based on patterns of occupancy.

Generally, universal DR remote-control device 108 will comprise a handheld device intended to be held in the hand of a user. In such an embodiment, universal DR remote-control device 108 will also include a battery-based power supply (not depicted). Batteries may be replaceable, and/or rechargeable.

A handheld version of universal DR remote-control device 108 may be used in conjunction with master station 118. As discussed briefly above, master station 118 may plug into an electrical wall outlet, and provide charging capability for device 108. Master station 118 may also receive one or more universal DR remote-control devices 108 in such a manner as to position a device 108 to be in an optimal position to transmit and/or receive wireless signals. When first local-communications module is an IR module transmitting an IR signal to an IR-responsive control unit of split system 110, properly positioning, or aiming, of the IR emitting portion of transceiver 150 toward split system 110 increases the likelihood of successful local communication between device 108 and split system 110.

In the embodiment depicted, master station 118 may be connected to power supply 122 via cable 144. Power supply 122 provides power from an electrical outlet to master station 118 for charging universal DR remote-control device 108. In one embodiment, power supply 122 is a “wall wart” style power supply, comprising a box-like housing that plugs directly into a wall-mounted electrical supply socket. Power supply 122 and master station 118 may be adapted to operate with various electrical supply voltage and frequency characteristics, such as 110-120V/60 Hz as commonly used in the United States, 220-240V/50 Hz as commonly used in Europe and Asia, as well as others. Power supply 122 may comprise a transformer or other power conversion electronics to convert an alternating-current to a direct-current supply for charging device 108.

Power supply 122 in an embodiment, may also comprise a power monitor having a processor 164 and other hardware, software, and/or firmware required for monitoring and analyzing power supply quality at an electrical power source. In an embodiment, power supply 122 with monitoring capability, may detect low line voltage conditions (“line-under voltage” or LUV) and/or low frequency conditions (“line-under frequency” or LUF). As discussed further below with respect to FIG. 3, when a LUV or LUF condition is sensed locally, power supply and monitor 122 will communicate the sensed under-voltage or under-frequency condition to universal DR remote-control device 108, causing device 108 to initiate control of split system 110 during the unfavorable power quality condition. Such communication may be made via cable 144. Power supply and monitor 122 may also log power quality data for later analysis and transmission.

Cable 144, in addition to supplying power to master station 118, may also include antenna portions so that cable 144 also serves as a long-distance antenna, facilitating communications over long-distance network 104. As discussed above, when power supply 122 is also a power monitor, cable 144 may also be a communications cable, enabling communication between power supply and monitor 122 and universal DR remote-control device 108.

In other embodiments, universal DR remote-control device 108 may be integrated into master station 118, and though generally portable for locating throughout premise 106, may not generally comprise a “handheld” device.

In yet other embodiments, some of the communications and processing capabilities described with respect to universal DR remote-control device 108 may be located in master station 118. In such an embodiment, any combination of long-distance communications module 130, first and second local-communications modules 132 and 134, and processor 138 may be housed in master station 118, with or without removing such capability from device 108.

In one such embodiment, master station 118 includes long-distance communications module 130, an RF local-communications module 134, and processor 138. Master station 118 communicates to one or more universal DR remote-control devices, each associated with one or more split systems 110.

Referring also to FIG. 3, local demand response system 170 operating in communication with master controller 102 over a long-distance communications network 104 is depicted. Although in the embodiment depicted, local demand response system 170 communicates directly with master controller 102, in other embodiments, system 170 may communicate with master controller 102 through intermediate or regional controllers. Such intermediate controllers may include a controller at a substation, a neighborhood controller, a business-wide controller, or other such intermediate-level controller. In related embodiments, the intermediate controller may be enabled to communicate regionally with system 170 without the benefit of a master controller 102.

Local demand-response system 170 includes one or more universal DR remote-control devices 108 with power supply and monitor 122, one or more inside units 114 of split system 110, one or more outside units 112 of split system 110, and one or more optional power sensors or current transformers 160.

In operation, master controller 102, transmits a load-control message over long-distance communications network 104 to multiple premises 106 (also see FIG. 1), including to the universal DR remote-control device 108 depicted in FIG. 3. The load-control message may include a variety of different commands related to controlling an electrical load, which may be an AC compressor, of split system 110. In one load-control scheme, a runtime of split system 110 is limited, sometimes configured as a duty-cycle percentage. For example, during peak energy usage, split system 110 may only be allowed to operate for 45 minutes of each hour, or a 75% duty cycle.

In another such load-control or demand-response scheme, an indicator of actual power consumed by an appliance during a plurality of output variations or cycles is monitored. Based on the monitoring, a level of maximum power consumed by the appliance during at least one period of full output, and an overall level of power consumed by the appliance over the plurality of output variations or cycles is computed. A baseline characteristic of actual energy consumption of the appliance is determined, and the appliance is operated according to a new operating regime that produces a target reduction in energy output.

In another load-control scheme, DR remote-control device 108 senses local space temperature, or receives temperature data, and either turns off split system 110, allowing the space temperature to rise, or alternatively, for split systems 110 having thermostatic capability, sends a command to split system 110 requesting that a space temperature set point be increased, so as to decrease the amount of time that split system 110 operates.

In an embodiment wherein DR remote-control device 108 includes temperature sensor 141, device 108 controls space temperature under normal conditions and during a load-control event by cycling split system 110 on and off. Such cycling would be accomplished by DR remote-control device 108 sensing space temperature, then sending an appropriate on or off command to inside unit 114 and its control unit. Other related commands may include a run fan command following the end of a run cycle of a load-control event. In dry regions, this added fan run time at the end of a cooling cycle would allow the re-evaporation of condensate on the heat exchanger, allowing the benefit of evaporative cooling where practical. In such embodiments, a user might be prompted to initialize split system 110 to be fully on or fully off prior to turning temperature control over to universal DR remote-control device 108.

Additional load-control, or demand-response, schemes that may be implemented are described further in U.S. Pat. No. 7,355,301, entitled “Load Control Receiver with Line Under voltage and Line Under Frequency Detecting and Load shedding”, U.S. Pat. No. 7,242,114 and U.S. Pat. No. 7,595,567, both entitled “Thermostat Device with Line Under Frequency Detection and Load Shedding Capability”, and U.S. Pat. No. 7,528,503, entitled “Load Shedding Control for Cycled or Variable Load Appliances”, commonly assigned to the assignees of the present application, and herein incorporated by reference in their entireties.

Load-control messages are received over long-distance communications network 104 by long-distance communications module 130 of DR remote-control device 108. These load-control messages may include messages such as timed-control messages, cycling-control messages, restore-control messages, and thermostat set-point control messages, some of which are described in U.S. Pat. No. 7,702,424 and U.S. Pat. No. 7,869,904 as described and cited above. Other load-control messages may request return data such as confirmation of messages received, energy usage data, local condition data, and so on.

In an embodiment, DR remote-control device 108 implements a load-control scheme based on critical or peak pricing received over long-distance communications network 104, with or without input from a user. A peak-price command may be stored in DR remote-control device 108 for implementation when received pricing information indicates energy prices rising above a critical price point. In an embodiment, a control command may automatically be implemented, but in another embodiment, a user may provide input, such as setting the critical price point or determining the command, such as raise the temperature, or turn off split system 108. In systems having more than one split system 110, received pricing information may cause different split systems 110 to implement different commands, depending on user input or preprogrammed settings.

Processor 138 receives the load-control messages and their data payload including load-control commands, analyzes the data, and determines appropriate commands to be sent to one or both of first and second local-communications modules 132 and 134. Processor 138 may also translate the load-control messages or commands to a format or protocol usable by communications modules 132 and 134. However, in some embodiments, any necessary protocol translation may be made in full or in part by one or both of local communications modules 132 or 134.

Processor 138 may also communicate information regarding the implementation, status, or conditions relating to control of split system 110 to display 140 for a user to view.

Commands to control split system 110 are transmitted from transceiver 150 of first communications module 130 to a control unit of split system 110. A typical control unit of a split system 110 includes a sensor for receiving operational commands from the originally-supplied, handheld remote-controller. Such control units may be IR-responsive control units with phototransistors for receiving IR signals. In some embodiments, the control unit may be capable of transmitting data relating to the operation of a split system 110. Once the original remote controller is replaced by universal DR remote-control device 108, first communications module 130 now provides operational commands to the control unit of split system 110. These operational commands may be associated with a load-control message received from master controller 102 for implementation of a load-control scheme, such as “turn off” system 108, or may be in response to input from a user via input 136 during normal operation of split system 110, such as a user operating DR remote-control device to simply turn split system 110 on to cool the premise. In an embodiment, because the control unit of split system 108 has not been modified for demand-response schemes, nor equipped with specialized demand-response hardware or software, the control unit does not differentiate between command signals caused by a user providing input to DR remote-control device 108 or caused by a master controller 102 providing load-control messages to DR remote-control device 108.

In one embodiment, first local communications module 132 of universal DR remote-control device 108 transmits an IR command signal 124 to split system 110 that is received by the control unit of split system 110, and thereby acted upon. In another embodiment, module 132 transmits an RF signal 124, such as a Zigbee or ZWave formatted signal to split system 110. If split system 110 includes an RF sensor as part of its control unit, the RF signal will be recognized. If split system 110 does not include RF capability, an RF to IR converter as understood by those skilled in the art may be placed over the IR receiver/sensor of the control unit of split system 110.

Because split system 110 may be controlled by a user operating universal DR remote-control device 108 for normal, non-demand-response control of split system 110 and may also be controlled by a master controller 102 operating universal DR remote-control 108 for load-control purposes, conflicts may arise. Universal DR remote-control 108 may be configured by a utility to include conflict rules that determine how split system 110 is to be controlled in the event of a conflict.

In an embodiment, the utility may choose to program universal DR remote-control device 108 to follow load-control messages transmitted by the utility without considering input from a user during a load-control event. Such an arrangement would prohibit a user from overriding the utility's control of split system 110. In such an arrangement, and if a temperature sensor is present in split system 110 or remote-control device 108, the space temperature at the premise may be allowed to rise during a load-control event to a maximum set-point temperature. Such an arrangement might be appropriate for voluntary programs that include the utility rebating fees on a regular basis, perhaps monthly, to a user merely based on participation in the program.

In another embodiment, a user may always be able to override control of split system 110 using universal DR remote-control device 108. In such an arrangement, a user may receive program fee credit, or billing reduction, based on allowing the utility to control split system 110, and not overriding operation of universal DR remote-control device 108 during load-control events.

In some embodiments, prior to, and during, a load-control event, display 140 may advise a user of the control status of split system 110, including whether a load-control event is imminent, taking place, or next scheduled. Other details may also be exhibited to a user regarding load-control information, energy usage, energy costs, and other such energy and load-control information.

Display 140 in conjunction with input 136, which in an embodiment is a key pad, allows a user to input relevant data into universal DR remote-control device 108 and monitor the activities of DR remote-control device 108. Although data input by a user may be relevant to local conditions at premise 106, such as requesting an increase in temperature or turning split system on and off, in an embodiment that includes two-way communication over long-distance communications network 104, a user may provide information directly to the utility. Such information may include local-condition information, run-time data, local supply voltage, local supply frequency, participation in a utility-sponsored demand response program, and so on. In some embodiments, such information may also include information received from inside unit 114, including data relating to the operational state of unit 114, confirmation of connection to inside unit 114, or other such data and information.

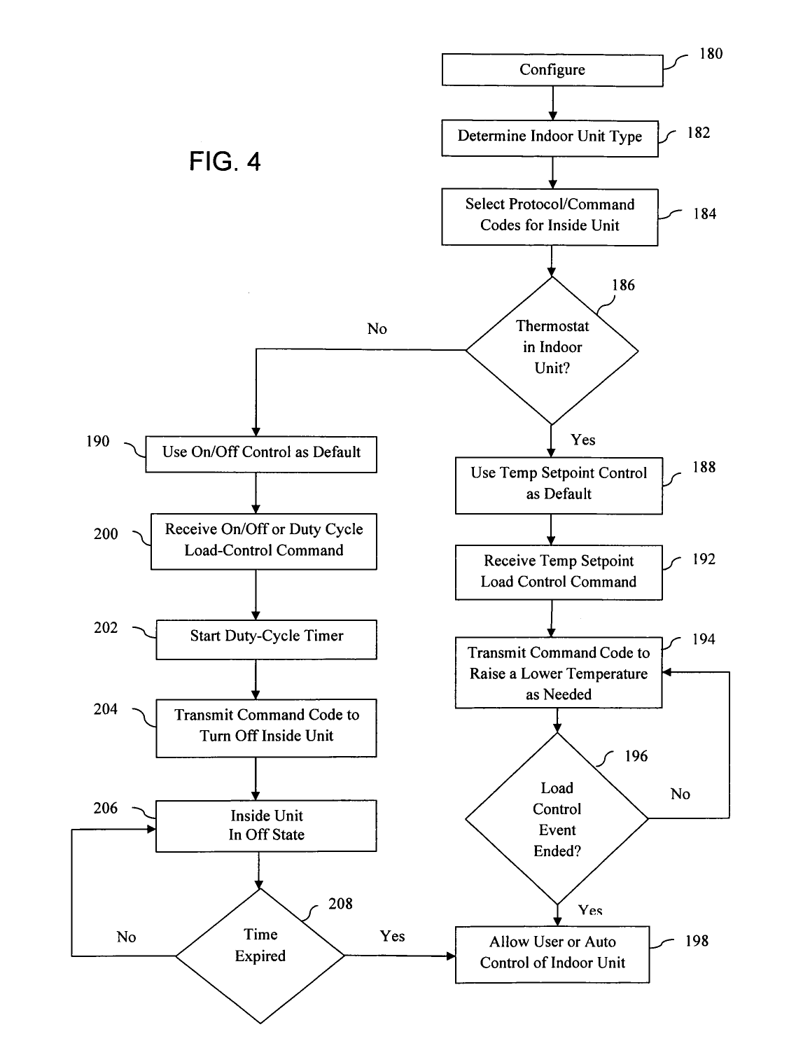

Referring also to FIG. 4, a flowchart summarizing the universal operating properties of DR remote-control device 108 is depicted. At step 180, configuration of universal DR remote-control device begins.

At step 182, the type of inside unit 114 is determined. Determining the “type” of inside unit 114 may comprise indentifying the brand, model, or other distinguishing information so that DR remote-control device 108 may be configured to communicate with inside unit 114. For example, inside unit 114 may comprise a particular brand and model that includes a control unit configured to receive a communications signal from the original manufacturers remote control device. The original remote-control device may emit an IR communications signal operating under a particular protocol and implementing particular command codes to the control unit of inside unit 114. Such protocols may include known remote-control protocols such as the Philips® IR-based RC-5 protocol, or other such protocols, and may include command codes for implementing the various operational functions of inside unit 114.

The step of determining or identifying the type of inside unit 114 may be accomplished in a number of ways. In an embodiment, a user enters a type of inside unit 114 into DR remote-control device 108 directly, or enters information into DR remote-control device 108 allowing an interactive identification of inside unit 114. In another embodiment, a user may inform a supplier of DR remote-control device 108 in advance of the type of inside unit 114. In such a case, DR remote-control device 108 may be preconfigured to operate with inside unit 114. In yet another embodiment, data relating to the type of inside unit 114 is transmitted over long-distance communications network 104 or from inside unit 114, to DR remote-control unit 108. In an embodiment, identifying or determining the type of inside unit 118 includes determining whether inside unit 114 includes a thermostat.

At step 184, with the knowledge of the type of inside unit 114, a protocol and/or one or more command codes for controlling inside unit 114 are selected. In an embodiment, DR remote-control device 108 may include a lookup table containing common control codes used by various manufacturers. In another embodiment, DR remote-control device 108 may communicate over long-distance communications network 104 to request and/or receive protocol and/or command codes for a particular inside unit 114. The command codes are used by DR remote-control device 108 to control functions such as on/off, temperature setpoint, and so on.

In the embodiment depicted, at step 186, if inside unit 114 includes a thermostat, as determined by information associated with the type of unit, step 188 is implemented, wherein temperature setpoints and offsets may be used to implement temperature-based load-control schemes, such as the ones discussed above. If inside unit 114 is not equipped with a thermostat, at step 190, on/off control of inside unit 114 may be used to implement a load-control scheme, such as a load-control scheme based on duty-cycle time. A duty-cycle may be determined in a number of ways, as discussed with respect to particular load-control schemes. Although a simple timer-based duty-cycle implementation of a load-control scheme is depicted and described at steps 190 to 208, it will be understood that any load-control scheme that turns inside unit on and off as part of a load-control scheme is encompassed by the depicted steps. Further, in some embodiments, even if inside unit 114 does not have a thermostat, if DR remote-control device 108 includes a temperature sensor, a temperature setpoint or offset type of control may be used at step 188, implemented through on/off control of inside unit 114.

When a temperature setpoint or offset control is used, at step 192, a load control command is received. At step 194, an appropriate command or control code is transmitted from DR remote-control unit 108 to a controller or control unit of inside unit 114. The transmitted control code may command inside unit 114 to raise (or lower) the temperature setpoint by a predetermined number of degrees, set the temperature to a predetermined set point, and so on.

At step 196, if the load-control event is completed, and DR remote-control device 108 no longer is actively controlling or commanding inside unit 114, control of inside unit 114 is returned to a user. At that point, a user may operate universal DR remote-control device 108 to control inside unit 114 as desired.

In some embodiments, a user may also be able to override the implementation of a load-control event. In other embodiments, control may only returned to a user when the event is concluded, when a critical temperature is reached, or under other predetermined circumstances.

If inside unit 114 does not include a thermostat, inside unit 114 may be cycled on and off as a means of implementing a load-control event, as depicted at step 190. At step 200, a load-control command is received. The received load-control command may require on/off control of inside unit 114 for implementation, such as a duty-cycle-based load control command as discussed above. In the embodiment depicted, the load-control command implements a timer-based duty-cycle-based load control command or set of commands.

In one such embodiment that relies on a timer, at step 202, a timer is started, followed by transmission of a command code to turn on or off inside unit 114 at step 204, such that at step 206, inside unit 114 is off. In an embodiment, a duty cycle may be 50%, such that inside unit 114 is turned off for 30 minutes every hour.

At step 208, in this timer-based embodiment, if time has not expired, inside unit 114 remains off, or if time has expired, control of inside unit 114 is turned over to a user and/or to a control unit of inside unit 114.

Referring again to FIG. 1, a universal DR remote-control device 108 may be used in premises 106 having more than one split system 110. In a multi-unit building with distinct residences or billing units, master controller 102 may communicate directly with each individual universal DR remote-control device 108, and no operational distinction may exist between any one unit having one split system 110 as compared to a stand-alone, single-unit premise 106.

Further, when multiple split systems 110 are present at a single unit or premise 106, each split system 110 may be associated with its own universal DR remote-control device 108. In such a system, each universal DR remote-control device 108 may be operated independently during load-control events by a master controller 102, another controlling device, or otherwise by a user.

However, in another embodiment, it may be beneficial to coordinate operation of multiple split systems 110 at a single premise 106 during a load-control event. As depicted in FIG. 1, a demand-response system at premise 106d includes first split system 110a with outside unit 112a and inside unit 114a, second split system 110b with outside unit 112b and inside unit 114b. The system also includes first and second universal DR remote-control devices 108a and 108b, as well as a single master station 118d.

Referring also to FIG. 2, in this embodiment, master station 118d comprises a long-distance communications module 130, as well as a local communications module 132 or 134 for communicating with first and second universal DR remote-control devices 108a and 108b. Master station 118d may transmit, and in some cases receive, local communication signals according to any of a variety of known, short-range wireless RF protocols including Bluetooth®, ZigBee, ZWave, WiFi, and others. In other embodiments, master station 118d transmits an IR signal. However, for premises 106d having split system 108a and 108b, both not in ready view of master station 118d, an RF signal may be most effective due to the directional properties of an IR signal.

Each of first and second universal DR remote-control devices 108a and 108b include transceivers 150 for receiving local communication signals 125 from master station 118d, and for transmitting local communication signals 124 to their respective split systems 110a and 110b. Because master station 118d includes a long-distance communications module 130, universal DR remote-control devices 108a and 108b in an embodiment may not include a long-distance communications module 130. Universal DR remote-control devices 108a and 108b may transmit commands to control units of split systems 108a and 108b via an IR transmission, or according to any of the local, short-range RF wireless protocols as described above.

Consequently, in operation, a load-control message is transmitted from master controller 102 to master station 118d at premise 106d. Master station 118d receives the load-control message via long-distance communications module 130 and long-distance communications network 104, processes the message, and transmits command signal 125 to one or both of universal DR remote-control devices 108a and 108b via local communications module 134. Universal DR remote-control devices 108a and 108b receive command signal 125, then when appropriate, transmit command signal 124 to their respective split systems 110a and 110b.

Any combination of wired, wireless, RF, IR, and other signal transmissions and protocols as described above may be used. In an embodiment, master controller 102 transmits an RF paging signal using a proprietary communications protocol to master station 118d; master station 118d transmits a Bluetooth transmission signal 125 to universal DR remote-control devices 108a and 108b; and universal DR remote-control devices 108a and 108b each transmit an IR command signal 124 to control units of split systems 110a and 110b, respectively.

Referring to FIGS. 2 and 3, demand response system 170 of the present invention may also include additional sensors and devices in communication with universal DR remote-control device 108. One such device includes power sensor 160, which in the depicted embodiment, comprises a current transformer monitoring a power line of an electrical load, such as a load associated with split system 110. In other embodiments, power sensors other than current transformers may be used, including voltage sensors, and other electrical devices that determine whether a load is powered.

In the embodiment depicted, power sensor 160 monitors a power line of outside unit 112 of split system 108. Power sensor 160 in the depicted embodiment includes electrical circuitry for detecting current flow through the power line, including a current transformer thereby detecting power to outside unit 112.

In addition to power-sensing capability, power sensor 160 may include data processing, data storage, and communications capability. In an embodiment, and as depicted, power sensor 160 includes processor 172 and local communications module 174. Processor 172 may also include memory devices such as those described above, or be in communication with such memory devices which may be integral to power sensor 160 or separate from power sensor 160. Communications module 174 in an embodiment includes a transmitter or transceiver for transmitting a short-range, wireless signal to universal DR remote-control device 108.

In operation, power sensor 160 monitors power to the electrical load, which may be an AC compressor of outside unit 112 of split system 108. Processor 172 records or logs sensed power data. Such data may include the amount of time that the electrical load of outside unit is powered, time of day, actual current or voltage, and other such sensed power data.

Local communications module 174 transmits real-time data, or logged data, to universal DR remote-control device 108. Data received at universal DR remote-control device 108 may then be saved in memory at DR remote-control device 108 and/or transmitted by remote-control device 108 over long-distance communications network 104 to a utility.

Logged data from power sensor 160 may be analyzed by DR remote-control unit 108, or by a utility to determine or refine a load-control scheme. In an embodiment, an average duty cycle of outside unit 112 is determined based on data sensed by power sensor 160. That data may then be used to determine a time interval for controlling the load of outside unit 112, including determining a time interval for removing power to the electrical load. Such analysis may take place at DR remote-control device 108, or remotely at a utility.

Such data is also useful for verifying that split system 108 is being controlled by universal DR remote-control device 108 as intended. If a user overrides or disables DR remote-control device 108, or a wireless signal commanding control of a load of split system 110 is not received by the control unit of split system 110, data from power sensor 160 can be analyzed to verify the success of failure of the load control event. In an embodiment, a load-control scheme limits the amount of time that a load of split system 108 may operate. Power sensor 160 records the run time of the load over time. Processor 138, processor 172, or a utility analyzes the data associated with the run time of the load and determines whether the run time exceeded the amount of time that the load should have been powered during the load-control event, thusly determining that the load-control event was not successful. Other embodiments may include other analytical techniques for providing feedback to a utility on the implementation of a load-control event.

Such data also enables advanced load-control schemes such as those described in the US patents cited above and incorporated by reference.

Still referring to FIGS. 2 and 3, in an embodiment, demand-response system 170 also includes sensing capability via power supply and monitor 122. As discussed briefly above, power supply and monitor 122 monitors power quality available at premise 106, including LUV and LUF conditions, and communicates associated data to universal DR remote-control 108.

In an embodiment, power supply and monitor 122 includes a processor 164 with or without memory devices, and other electrical hardware, software, and firmware necessary to measure power quality of electrical power at the power source. Apparatuses, systems, and methods for detecting power conditions are described further in U.S. Pat. No. 7,242,114, U.S. Pat. No. 7,355,301, and U.S. Pat. No. 7,595,567, as cited above and incorporated by reference. In one such method, power supply and monitor 122 samples a voltage source at regular time intervals, thereby generating a series of voltage readings, and compares the voltage readings to an under voltage trigger threshold. If an under voltage condition is detected, then an under voltage in-response cycle is initialized that controls the electrical load. When the voltage readings decrease to below a voltage-power fail level, a plurality of load restore counter values are stored in memory before the load is shed from the primary voltage source. In an embodiment, this may entail powering off split system 110, or decreasing a temperature set point to accomplish same. A restore response is then initialized after the voltage level rises above a restore value and is maintained above the restore value for an under voltage out-time period.

In another such method, power supply and monitor 122 measures the time period of each power line cycle and then compares the measured time period to a utility-configurable trigger period. If the cycle length is greater than or equal to the trigger period, a counter is incremented. If the cycle is less than the trigger period, the counter is decremented. If the counter is incremented to a counter trigger, an under-frequency condition is detected and DR remote-control device 108 begins controlling split system 110. A restore response is initialized after the frequency rises above a restore value and an under-frequency counter counts down to zero.

In an embodiment, data from power supply and monitor 122 may be transmitted serially over cable 144 to universal DR remote-control device 108 for further processing, storage, forwarding or action. Processor 138 of DR remote-control device 108 may implement a load-control scheme based solely on local data, including power quality data collected by, and received from, power supply and monitor 122, or may modify a load-control scheme as embodied in load-control messages received from master controller 102.

In other embodiments, power supply and monitor 122 designed to support measurement and verification efforts may include an additional communications module, which may be an RF module, for long-distance communication directly over communications network 104, or another long-distance communications network other than network 104.

In other embodiments, system 170 may also include additional electrical loads and/or monitoring devices in communication with universal DR remote-control device 108. Additional electrical loads may include hot water heaters, electric heaters, fans, appliances and other such devices having electrical loads. Each of these additional loads may include an associated power sensor 160, which may be a current transformer, and may include a processor and local-communications module. Power sensor 160 monitors power flow to the load and communicates data to DR remote-control device 108.

In some embodiments that include additional loads, DR remote-control device 108 may not provide direct user control over the load, but rather, would control loads automatically during load control events initiated and controlled by DR remote-control device 108.

Although the present invention has been described with respect to the various embodiments, it will be understood that numerous insubstantial changes in configuration, arrangement or appearance of the elements of the present invention can be made without departing from the intended scope of the present invention. Accordingly, it is intended that the scope of the present invention be determined by the claims as set forth.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A universal demand-response remote-control device for controlling an infrared-responsive control unit of a ductless, split air-conditioning system, the remote-control device comprising:
a long-distance communications module including a long-distance transceiver, the long-distance communications module providing a network connection to a long-distance communications network transmitting a load-control message for controlling an electrical load of a ductless, split air-conditioning system at a premise;
a processor in electrical communication with the long-distance communications module;
a first local communications module in electrical communication with the processor and the long-distance communications module, the first local-communications module including a local transceiver transmitting a command associated with the received load-control message to an infrared-responsive control unit of the ductless, split air-conditioning system located inside the premise to control operation of the electrical load, wherein the infrared-responsive control unit is located inside the premise, and the electrical load is located outside the premise.

2. The remote-control device of claim 1, further comprising a key pad receiving control input from a user to enable the user to manually control operation of the ductless, split air-conditioning system.

3. The remote-control device of claim 1, further comprising a housing enclosing the long-distance communications module, the processor and the first local-communications module, the housing adapted to be held by a user operating the remote-control device and including a battery to power the remote control device.

4. The remote-control device of claim 3, further comprising a display.

5. The remote-control device of claim 1, wherein the first local communications module comprises an infrared communications module transmitting an infrared signal to the control unit.

6. The remote-control device of claim 1, wherein the first local communications module comprises a radio-frequency (RF) communications module transmitting an RF signal to an RF to infrared converter at the control unit.

7. The remote-control device of claim 1, further comprising a second local communications module, the second local communications module communicating with devices other than the control unit of the ductless, split air-conditioning system.

8. The remote-control device of claim 7, further comprising a power sensor adapted to sense power at the electrical load, and to communicate data associated with the power at the electrical load to the second local communications module.

9. The remote-control device of claim 1, wherein the air-conditioning system is a cooling system, and the electrical load is a compressor.

10. The remote-control device of claim 1, further comprising a power supply and monitor device in communication with the processor of the remote-control device and providing data associated with a power quality of an electrical power supply to the remote-control device.

11. The remote-control device of claim 3, further comprising a master station, the master station including structure that mates with a portion of the remote-control device and circuitry that charges a battery of the remote-control device.

12. The remote control device of claim 11, wherein the master station further comprises a cable connected to a power supply device, the cable comprising an antenna for the long distance communications module.

13. The remote-control device of claim 1, wherein the local transceiver comprises a one-way, receive-only device.

14. A remote-control system for controlling a plurality of ductless, split air-conditioning units, the remote-control system comprising:
a master station including:
a long-distance communications module including a long-distance transceiver, the long-distance communications module providing a network connection to a long-distance communications network transmitting load-control messages for controlling electrical loads of one or more ductless, split air-conditioning systems;
a local-communications module including a local transceiver;
a processor in electrical communication with the long-distance communications module and the master local-communications module;
a first, battery-operated handheld remote-control device in communication with the master station, including:
a local communications module including a local transceiver receiving load-control message data from the master station and transmitting commands associated with the load-control message data to a first inside, infrared-responsive control unit of the one or more ductless, split air-conditioning systems, thereby controlling operation of a first outside electrical load of the one or more ductless, split air-conditioning systems; and
a second, handheld remote-control device in communication with the master station, including:
a local communications module including a local transceiver receiving load-control message data from the master station and transmitting commands associated with the load-control message data to a second inside, infrared-responsive control unit of the one or more ductless, split air-conditioning systems, thereby controlling operation of a second outside electrical load of the one or more ductless, split air-conditioning systems.

15. The system of claim 14, wherein the long-distance communications network comprises a long-distance radio-frequency (RF) communications network, the local transceiver of the master station comprises an RF transceiver, and the local transceivers of the first and second handheld remote-control devices comprise infrared transmitters.

16. The system of claim 15, wherein the long distance transceiver of the master station comprises a one-way, receive-only device.

17. A method of controlling an electrical load of a ductless, split air-conditioning system outside a premise and controlled by a remote-control device located inside the premise, the method comprising:
causing a remote-control device having a long-distance communications module and a local communications module to be provided to a user for use inside the premise, the long-distance communications module configured to interface with a long-distance communications network and the local communications module configured to communicate with an inside infrared-responsive control unit of a ductless, split air-conditioning system at the premise having an outside unit with an electrical load;
transmitting a load-control message over the long-distance communications network to the long-distance communications module of the remote-control device located inside the premise, the load-control message causing the remote-control unit to transmit a load-control command to the inside control unit of the indoor portion of the ductless, split air-conditioning unit, thereby controlling power to the electrical load.

18. The method of claim 17, wherein transmitting a load-control message over the long-distance communications network comprises transmitting a load-control message over a radio-frequency (RF) long-distance communications network.

19. The method of claim 17, wherein the remote-control unit is configured to transmit the load-control command to the inside control unit of the indoor portion of the ductless, split air-conditioning unit using an infrared (IR) signal.

20. The method of claim 17, further comprising receiving data over the long-distance communication network, the data associated with energy usage of the electrical load as transmitted from the remote-control device.
